(19) United States
(12) Patent Application Publication
(10) Pub. No.: US 2024/0402433 A1
(43) Pub. Date: Dec. 5, 2024

(54) DIFFRACTIVE OPTICAL WAVEGUIDE AND AR GLASSES

(71) Applicant: ZHUHAI MOJIE TECHNOLOGY CO., LTD., Zhuhai (CN)

(72) Inventors: Chendi SHAO, Zhuhai (CN); Jian GUAN, Zhuhai (CN); Fuyang LAN, Zhuhai (CN); Zhu LI, Zhuhai (CN)

(21) Appl. No.: 18/804,048

(22) Filed: Aug. 14, 2024

Related U.S. Application Data
(63) Continuation of application No. PCT/CN2023/075512, filed on Feb. 10, 2023.

(30) Foreign Application Priority Data
Feb. 14, 2022 (CN) 202210134265.5

(51) Int. Cl. G02B 6/34; G02B 27/01

(52) U.S. Cl. CPC G02B 6/34; G02B 27/0172; G02B 2027/0123; G02B 2027/0178

(57) ABSTRACT

A diffractive optical waveguide includes: an optical waveguide substrate, at least one coupling-in grating, at least one relay grating, and at least one coupling-out grating. The coupling-in grating is arranged in the coupling-in region. The relay grating is arranged in the relay region. The coupling-out grating is arranged in the coupling-out region. The relay grating and the coupling-out grating are both two-dimensional gratings. The coupling-in region and the coupling-out region are both symmetrical in shape, the relay grating is symmetrical or asymmetrical in shape. Thus, the relay grating can change a transmission path of part of lights, the lights coupled-in from the coupling-in grating can be transmitted to the coupling-out region through the relay grating and cover the entire coupling-out region, avoiding the problem of dark angle of fields of view in the coupling-out region and improving energy utilization efficiency of the lights.

### CROSS-REFERENCE TO RELATED APPLICATIONS

The present disclosure is a continuation of International Patent Application No. PCT/CN2023/075512 filed on Feb. 10, 2023, which claims priority of the Chinese Patent application No. 202210134265.5 entitled “DIFFRACTIVE OPTICAL WAVEGUIDE AND AUGMENTED REALITY GLASSES” filed on Feb. 14, 2022 in the China National Intellectual Property Administration, the entire contents of which are incorporated herein by reference.

### FIELD OF THE DISCLOSURE

The present disclosure relates to the technical field of light emitting devices, in particular to a diffractive optical waveguide and an augmented reality glasses.

### DESCRIPTION OF THE RELATED ART

In the fields of augmented reality (AR) and mixed reality (MR), compared with Bird Bath (BB, semi-reflective and semi-transmissive), insect eye (off-axis reflective), free-form prism and other display solutions, the optical waveguide solution is lighter and thinner, and has a larger eye box, so it has a broader application prospect. The eye box refers to a two-dimensional region in which human eyes can completely see lights of a given field of view (complete virtual image) at a given viewing distance. In the fields of optical waveguide, compared with an array optical waveguide using a partial transflective film, production and preparation process of the diffractive optical waveguide is less difficult, and there is no grid-like dark stripes when realizing two-dimensional pupil expansion (exit pupil expansion in two dimensions). Therefore, the diffractive optical waveguides are more popular.

The research challenges of diffractive optical waveguides lie in how to provide a more uniform display effect and further enlarge the region of the eye box. Compared to an optical waveguide design scheme with a full one-dimensional grating, an optical waveguide design scheme with a two-dimensional grating proposed by a patent U.S. Pat. No. 10,359,635B2 can achieve two-dimensional pupil expansion without a deflecting region, thus having a larger coupling-out region, and providing a larger eye box. However, there is usually a central bright stripe when coupling out, and there may be a loss of fields of view in corner area, that is, uniformity of fields of view is relatively poor when viewing. A patent GB2578328A utilizes the design freedom of microstructures to improve uniformity of the fields to a certain extent, but it is difficult to improve edge vignetting caused by limited propagation paths. The current optical waveguide design scheme with a two-dimensional grating usually has problems of large grating processing region (including ineffective regions) and high diffraction energy loss.

Therefore, related art needs to be improved and developed.

### SUMMARY OF THE DISCLOSURE

In one aspect, the present disclosure provides a diffractive optical waveguide, including:
an optical waveguide substrate, and at least one coupling-in region, at least one relay region, and at least one coupling-out region disposed on the optical waveguide substrate; each relay region is arranged between the coupling-in region and the coupling-out region;
a coupling-in grating, arranged in the coupling-in region, the coupling-in grating is configured to couple lights into the optical waveguide substrate and transmit the lights to the relay region and the coupling-out region; the coupling-in grating is a one-dimensional grating or a two-dimensional grating;
a relay grating, arranged in the relay region, the relay grating is configured to change a transmission path of the lights so that the lights cover the coupling-out region; and
a coupling-out grating, arranged in the coupling-out region, the coupling-out grating is configured to couple lights out from the coupling-out region, the relay grating and the coupling-out grating are both two-dimensional gratings, the coupling-in region and the coupling-out region are both symmetrical in shape, the relay region is symmetrical or asymmetrical in shape.

In another aspect, the present disclosure provides an augmented reality, the augmented reality glasses includes an optical machine, and a diffractive optical waveguide as described in any of the above technical solutions; the optical machine is configured to emit signal lights towards the diffractive optical waveguide, the diffractive optical waveguide couples in the signal lights and couples out the signal lights to human eyes.

In the third aspect, the present disclosure provides a display device, the display device includes an optical machine, and a diffractive optical waveguide as described in any of the above technical solutions; the optical machine is configured to emit signal lights towards the diffractive optical waveguide, the diffractive optical waveguide couples in the signal lights and couples out the signal lights to human eyes.

### BRIEF DESCRIPTION OF THE DRAWINGS

FIG. 1 is a schematic view illustrating a first type of geometric shape of a diffractive optical waveguide in related art;

FIG. 2 is a schematic view illustrating a second type of geometric shape of a diffractive optical waveguide in related art;

FIG. 3 is a first schematic view illustrating a diffractive optical waveguide according to one embodiment of the present disclosure;

FIG. 4 is a second schematic view illustrating a structure of a diffractive optical waveguide according to one embodiment of the present disclosure;

FIG. 5 is a schematic view illustrating a first type of geometric shape of a diffractive optical waveguide according to one embodiment of the present disclosure;

FIG. 6 is a schematic view illustrating a second type of geometric shape of a diffractive optical waveguide according to one embodiment of the present disclosure;

FIG. 7 is a schematic view illustrating a third type of geometric shape of a diffractive optical waveguide according to one embodiment of the present disclosure;

FIG. 8 is a schematic view illustrating a fourth type of geometric shape of a diffractive optical waveguide according to one embodiment of the present disclosure;

FIG. 9 is a schematic view illustrating a fifth type of geometric shape of a diffractive optical waveguide according to one embodiment of the present disclosure;

FIG. 10 is a schematic view illustrating a sixth type of geometric shape of a diffractive optical waveguide according to one embodiment of the present disclosure;

FIG. 11 is a schematic view illustrating a seventh type of geometric shape of a diffractive optical waveguide according to one embodiment of the present disclosure;

FIG. 12 is a schematic view illustrating a eighth type of geometric shape of a diffractive optical waveguide according to one embodiment of the present disclosure;

FIG. 13 is a schematic view illustrating structures of a diffractive optical waveguide in left-eye design scheme and a diffractive optical waveguide in right-eye design scheme according to one embodiment of the present disclosure;

FIG. 14 is a schematic view illustrating a transmission path of lights according to one embodiment of the present disclosure;

FIG. 15 is a schematic view illustrating a surface relief grating and a holographic grating according to one embodiment of the present disclosure;

FIG. 16 is a schematic view illustrating geometric shape of a diffractive optical waveguide partitioning a relay region and a coupling-out region into different regions according to another embodiment of the present disclosure;

FIG. 17 is a first schematic view illustrating a structure of a display device according to another embodiment of the present disclosure;

FIG. 18 is a second schematic view illustrating a structure of a display device according to another embodiment of the present disclosure.

### LIST OF REFERENCE SIGNS IN RELATED ART

1, coupling-in grating; 2, coupling-out grating; 3, deflecting grating.

### LIST OF REFERENCE SIGNS IN EMBODIMENTS OF THE PRESENT DISCLOSURE

10, coupling-in region; 20, coupling-out region; 30, relay region; 40, coupling-in grating; 50, coupling-out grating; 60, relay grating; 70, optical waveguide substrate; 200, optical machine; 300, human eye;
(a), straight groove envelope grating; (b), slant envelope grating; (c), blazed envelope grating; (d), step envelope grating; (e), curved envelope grating; (f), holographic grating.

### DETAILED DESCRIPTION

In order to facilitate an understanding of the present disclosure, a comprehensive description of the present disclosure will be further provided below with reference to the attached drawings. The drawings illustrate preferred embodiments of the present disclosure. However, the present disclosure may be embodied in many different forms and is not limited to embodiments described herein. On the contrary, the purpose of providing these embodiments is to make the disclosure of the present disclosure more thorough and comprehensive.

Unless otherwise defined, all technical and scientific terms used herein have the same meaning as commonly understood by those having ordinary skill in the art. The terminology used herein in the description of the present disclosure is only for the purpose of describing specific embodiments, and is not intended to limit the present disclosure.

It should be noted that when a component is referred to as being “fixed on” or “arranged on” another component, it may be directly on the another component or indirectly on the another component. When a component is described as being “connected to” another component, it may be directly connected to the another component or indirectly connected to the another component.

It should also be noted that in the drawings of embodiments of the present disclosure, the same or similar signs correspond to the same or similar components; in the description of the present disclosure, it is necessary to understand that terms such as “up”, “down”, “left”, “right”, etc., indicating the orientation or positional relationship, are based on the orientation or positional relationship shown in the drawings, and are only for the convenience of describing the present disclosure and simplifying the description, rather than indicating or implying that the referred device or element must have a specific orientation, construct and operate in a specific orientation. Therefore, terms describing the positional relationship in the drawings are for illustrative purposes only, and should not be construed as limitations on this patent. Those having ordinary skill in the art may understand the specific meaning of the above terms according to the specific circumstances.

Currently, in order to enlarge the eye box (usually by increasing the area of a coupling-out region), a diffractive optical waveguide in related art commonly uses a one-dimensional grating as a coupling-in grating 1, and a two-dimensional grating as a coupling-out grating 2. The geometric shape of the diffractive optical waveguide is shown in FIG. 1, lights are configured to be transmitted into the coupling-out grating 2 through the coupling-in grating 1, and generally divided into three directions for transmission. However, it is difficult for the lights to reach an upper left corner and a lower left corner of the coupling-out grating 2 (illustrated by position A and position B in FIG. 1), that is, the coupling-out energy of the lights in the position A and the position B is insufficient, which will lead to a loss of fields of view in some positions in the eye box. The loss of fields of view not only affects uniformity of image display, but also wastes a design size of the coupling-out grating 2 (the two-dimensional coupling-out grating has ineffective regions).

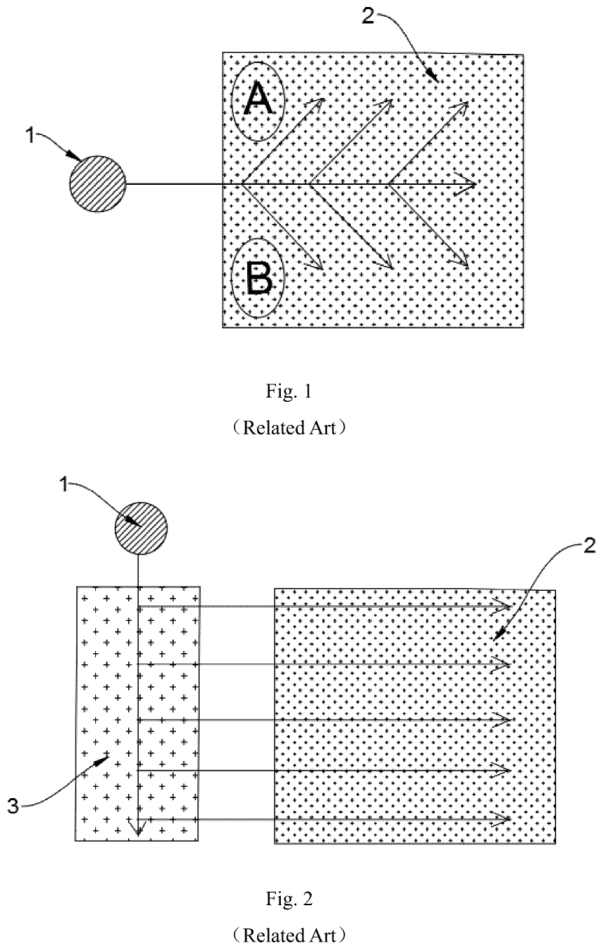

In order to solve the loss of fields of view in some positions, an existing solution is to design a deflecting grating 3 (in the present disclosure, the deflecting grating is specifically used to transform the transmission direction) between a coupling-in grating 1 and a coupling-out grating 2 to change a transmission path of part of lights. As shown in FIG. 2, lights coupled through the coupling grating 1 are transmitted to the deflecting grating 3 in a first spreading direction, and the deflecting grating 3 splits the lights transmitted in the first extended direction into multiple lights transmitted in a second extended direction, so that the multiple lights transmitted in the second extended direction may reach the upper left corner and the lower left corner of the coupling-out grating 2. However, the deflecting gratings usually need a larger region to be reserved, resulting in a limited coupling-out region and a smaller eye box. A second solution is configured as a butterfly-wing shape, dual one-dimensional gratings, and a deflecting region. This type of solution has a shorter turning zone and requires the deflecting region to have a higher diffraction efficiency. Additionally, with a limitation of the transmission path of lights, lights coupled out from the coupling-out region have a central dark stripe.

Thus, one embodiment of the present disclosure provides some solutions to solve the above technical problems, which may eliminating a loss of fields of view while improving energy utilization rate of lights. The details will be described in following embodiments.

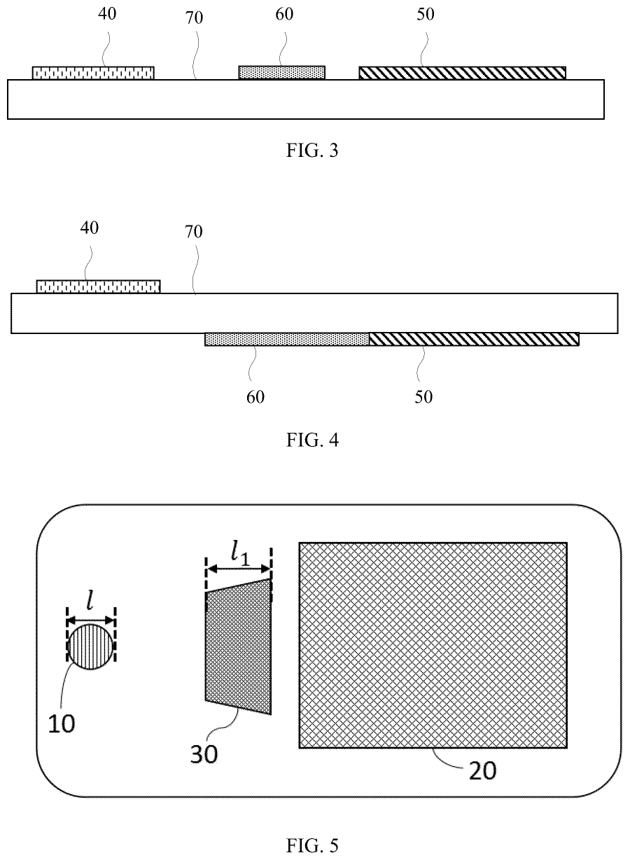

A diffractive optical waveguide, an augmented reality glasses and a display device provided by embodiments of the present disclosure will be described in detail below through specific embodiments and application scenarios with reference to FIG. 3 to FIG. 18.

As shown in FIG. 3 to FIG. 5, one embodiment of the present disclosure provides a diffractive optical waveguide, the diffractive optical waveguide includes: an optical waveguide substrate 70, and a coupling-in region 10, a relay region 30, and a coupling-out region 20 disposed on the optical waveguide substrate 70; the relay region 30 is arranged between the coupling-in region 10 and the coupling-out region 20; a coupling-in grating 40, arranged in the coupling-in region 10, wherein the coupling-in grating 40 is configured to couple lights into the optical waveguide substrate 70 and transmit the lights to the relay region 30 and the coupling-out region 20; a relay grating 60, arranged in the relay region 30, wherein the relay grating 60 is configured to change a transmission path of lights so that the lights may be transmitted from the relay region 30 to the coupling-out region 20, and cover entire area of the coupling-out region 20; a coupling-out grating 50, arranged in the coupling-out region 20 and wherein the coupling-out grating 50 is configured to couple lights out from the coupling-out region 20. Although the “relay region 30” in one embodiment of this patent also serves to change the transmission path of lights, it is not called a “deflecting region” because the “relay region 30” uses a two-dimensional grating, and the “deflecting region” uses a one-dimensional grating.

The optical waveguide substrate 70 is sequentially equipped with the coupling-in region 10, the relay region 30, and the coupling-out region 20. The relay region 30 is arranged between the coupling-in region 10 and the coupling-out region 20. The coupling-in region 10 is equipped with a coupling-in grating 40, which may be a one-dimensional grating or a two-dimensional grating. The relay region 30 is equipped with a relay grating 60, which is a two-dimensional grating.

Specifically, the diffractive optical waveguide may have single layer optical waveguide substrate, or multi-layer optical waveguide substrates. When the diffractive optical waveguide is configured with multi-layer optical waveguide substrates, each layer of optical waveguide substrate 70 is configured with a grating. In each layer of optical waveguide substrate 70, the coupling-in grating 40, the relay grating 60 and the coupling-out grating 50 may be positioned on the same side (as shown in FIG. 3) or different sides (as shown in FIG. 4) of the optical waveguide substrate 70. For example, as shown in FIG. 3, the coupling-in grating 40, the relay grating 60 and the coupling-out grating 50 may be positioned on the same side of the optical waveguide substrate 70. For example, as shown in FIG. 4, the coupling-in grating 40 may be positioned on a side of the optical waveguide substrate 70, the relay grating 60 and the coupling-out grating 50 may be positioned on an opposite side of the optical waveguide substrate 70. There is no gap between two gratings, and/or, there is a gap between two gratings. The coupling-in grating 40, the relay grating 60 and the coupling-out grating 50 may also be positioned inside the optical waveguide substrate 70. Those having ordinary skill in the art may design number, geometric shape, relative position (including difference between being positioned on the same side or different sides of the optical waveguide substrate 70), number of regions, and grating parameters of the coupling-in grating 40, the relay grating 60, and the coupling-out grating 50 according to the target viewing effect.

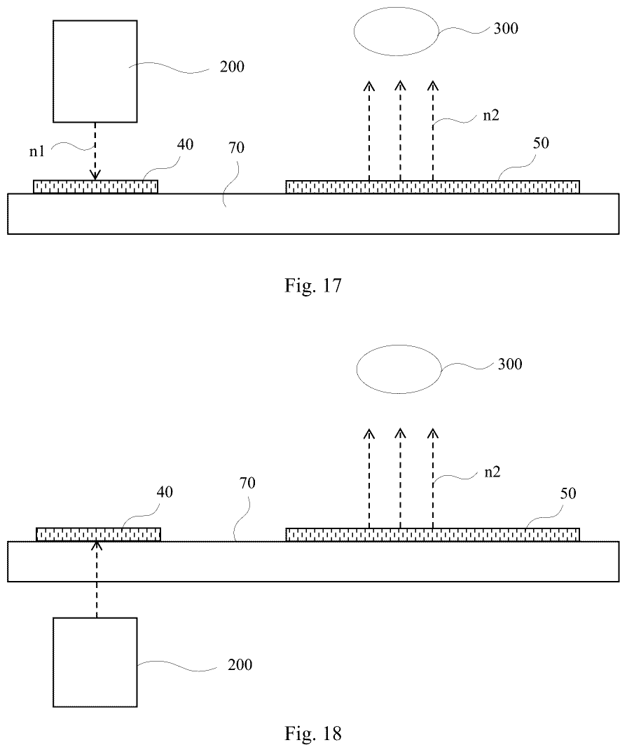

In one embodiment of the present disclosure, an optical machine 200 (As shown in FIG. 17) is generally arranged close to the coupling-in region 10. Taking FIG. 5 as an example, firstly, lights emitted from the optical machine 200 are coupled into the optical waveguide substrate 70 through the coupling-in grating 40 in the coupling-in region 10, and transmitted to the relay region 30 and the coupling-out region 20 in the form of total reflection in the optical waveguide substrate 70. As shown in FIG. 14, an angle between a direction of lights transmitted from the coupling-in region 10 and a horizontal direction is a, and and an angle between a direction of part of lights transmitted from the coupling-in region 10 and a horizontal direction is y. The relay grating 60 receives the lights transmitted from the coupling-in region 10, and changes a transmission path of the part of lights, so that the part of the lights are transmitted from the relay region 30 to target positions (corresponding to the upper left corner position A and the lower left corner position B in FIG. 1) of the coupling-out region 20, therefore the defect that coupling-out light energy is weak in the upper left corner and the lower left corner of the coupling-out region 20 (resulting in a loss of fields of view) can be overcome. The coupling-out grating 50 couples lights in the coupling-out region 20 out of the optical waveguide substrate 70, and human eyes 300 see corresponding images by receiving the lights.

It should be noted that, in one embodiment of the present disclosure, although the relay region 30 is a two-dimensional grating, it may theoretically couple out lights to the human eyes 300, but the coupling-out energy may be reduced and uniformity of beam splitting may be increased through designing microstructures. At the same time, the microstructures in the coupling-out region 20 may be designed to increase coupling-out energy. Therefore, the embodiment increases design freedom, improves the efficiency of light energy utilization, and enhances uniformity of the coupling-out energy.

In one embodiment, the coupling-in region 10, the relay region 30 and the coupling-out region 20 are both symmetrical or an asymmetrical in shape. In one embodiment, the coupling-in region 10 and the coupling-out region 20 are both symmetrical in shape, the relay region 30 is symmetrical or asymmetrical in shape. In one embodiment, the coupling-in region 10, the relay region 30, and the coupling-out region 20 have different shapes.

Specifically, the coupling-in region 10 may be circular in shape or a similar shape, such as one of the following shapes: an oval, rectangle, square, polygon, rounded rectangle, rectangle with chamfers, and other regular or irregular shapes. The coupling-out region 20 may be a rectangular shape or a similar shape, such as one of the following shapes: oval, rectangle, square, polygon, rounded rectangle, rectangle with chamfers, and other regular or irregular shape. The relay region 30 may be a symmetrical trapezoidal or an asymmetrical trapezoidal shape. The relay region 30 may also be other shapes derived from a trapezoidal shape, for example, slanted sides of the trapezoidal relay region is extended toward an upper base of the trapezoidal relay region to form a triangle shape, or the trapezoidal relay region may also have rounded corners, chamfered corners, or trimmed edges.

In one embodiment, the coupling-in region 10 is a circular shape, the coupling-out region 20 is a rectangular shape, and the relay region 30 is a symmetrical trapezoidal or an asymmetric trapezoidal shape. As shown in FIG. 9, the coupling-in region 10 is a circular shape or a similar shape, the coupling-out region 20 is a rectangle or a similar shape, and the relay region 30 is a trapezoidal shape or a trapezoidal-like shape.

As shown in FIG. 5 to FIG. 12 illustrate eight embodiments of the diffractive optical waveguide of the present disclosure. It should be noted that in following embodiments, a line connecting an equivalent center P1 of the coupling-in region 10 and an equivalent center P2 of the coupling-out region 20 is disposed as a main line, a direction perpendicular to the main line is disposed as a normal line.

In one embodiment, a side of the relay region 30 close to the coupling-in region 10 is perpendicular to the main line, an opposite side of the relay region 30 close to the coupling-out region 20 is perpendicular to the main line.

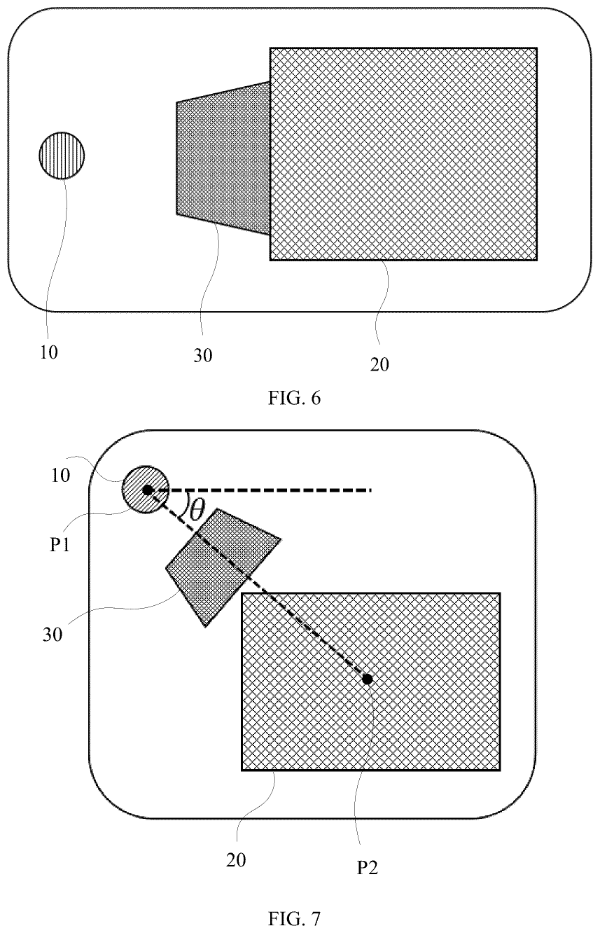

As shown in FIG. 5 and FIG. 6, an angle θ between a direction of the main line and a horizontal direction ranges from 0 degrees to 90 degrees, an upper base of the relay region 30 is close to the coupling-in region 10, and the upper base is perpendicular to the main line, a lower base of the relay region 30 is close to the coupling-out region 20, and the lower base is perpendicular to the main line, a straight-line distance between the upper base and the lower base of the relay region 30 along the direction of the main line is defined as a height l₁ of the relay region 30, the height l₁ is not less than a maximum distance l of the coupling-in region 10 along the main line.

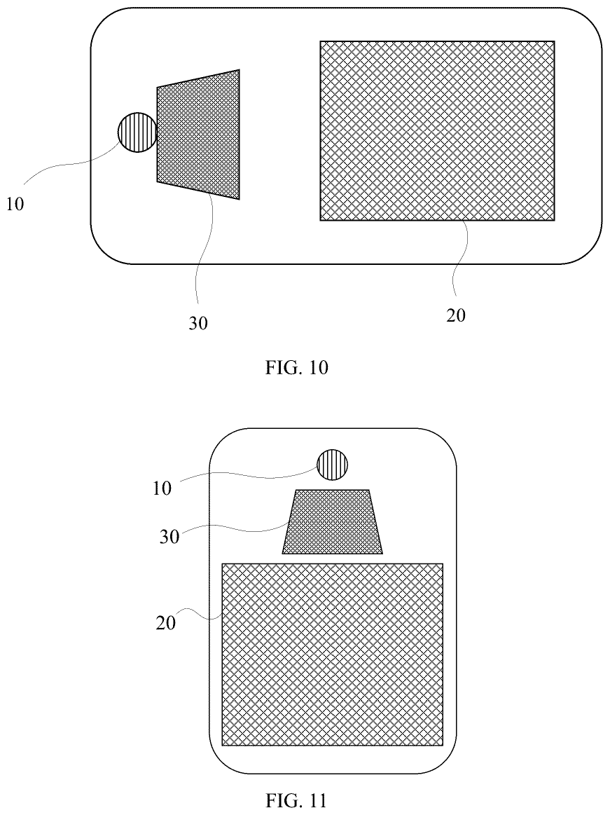

In FIG. 5 and FIG. 6, the main line is configured horizontally (that is, an angle θ between a direction of the main line and a horizontal direction is 0 degrees). In one embodiment, the relay region 30 is a trapezoidal shape. In one embodiment, the relay region 30 is an isosceles trapezoidal shape or a symmetrical trapezoidal-like shape. For example, the relay region 30 is a symmetrical trapezoidal shape, the coupling-in region 10 is a circular shape, the coupling-out region 20 is a rectangular shape. The coupling-in region 10, and the relay region 30 and the coupling-out region 20 are symmetrical about the main line. For example, the coupling-in region 10 in a circular shape, the relay region 30 in a symmetric trapezoidal shape and the coupling-out region 20 in a rectangular shape are both symmetrical about the main line. A height l₁ of the relay region 30 is not less than a maximum distance l of the coupling-in region 10 along the main line, so that a light spot coupled in from the coupling-in region 10 may completely fall into the relay region 30. An upper base of the relay region 30 is close to the coupling-in region 10 and parallel to the normal line (perpendicular to the main line), and a lower base of the relay region 30 is close to the coupling-out region 20 and parallel to the normal line (perpendicular to the main line). In particular, the area of the relay region 30 may be increased so that the upper base of the relay region 30 is connected to the coupling-in region 10 (as shown in FIG. 10), and/or, the lower base of the relay region 30 is connected to the coupling-out region 20 (as shown in FIG. 6). The lower base of the relay region 30 may also be the same length as a side of the coupling-out region 20 close to the relay region 30 (as shown in FIG. 16).

In one embodiment, the relay region 30 is a trapezoidal shape, the upper base of the trapezoidal relay region is connected to the coupling-in region 10, and/or, the lower base of the trapezoidal relay region is connected to the coupling-out region 20.

As shown in FIG. 7, the angle θ between the main line direction and the horizontal direction in FIG. 7 ranges from 0 degrees to 90 degrees. At this time, the relay region 30 may be a symmetrical/asymmetrical trapezoidal shape (in some special positions, the relay region 30 is a symmetrical trapezoidal shape, as shown in FIG. 7). A height of the symmetrical/asymmetrical trapezoidal relay region is not less than a maximum distance of the coupling-in region 10 along the main line, so that a light spot coupled in from the coupling-in region 10 may completely fall into the relay region 30, an upper base of the symmetrical/asymmetrical trapezoidal relay region is close to the coupling-in region 10 and parallel to the normal line (perpendicular to the main line), and a lower base of the symmetrical/asymmetrical trapezoidal relay region is close to the coupling-out region 20 and parallel to the normal line (perpendicular to the main line). In particular, the upper base of the symmetrical/asymmetrical trapezoidal relay region is connected to the coupling-in region 10, and/or, the lower base of the symmetrical/asymmetrical trapezoidal relay region is connected to the coupling-out region 20. As shown in FIG. 11, for example, an angle between a direction of the main line and a horizontal direction is 90 degrees, the relay region 30 is a symmetrical trapezoidal shape or an isosceles-like shape, the relay region 30 is symmetrical about the main line.

In one embodiment, an angle between a direction of the main line and a horizontal direction is 0 degrees, the relay region 30 is a symmetrical trapezoidal shape or an isosceles-like shape, the isosceles-like shape is symmetrical about the main line. In one embodiment, an angle between a direction of the main line and a horizontal direction is 90 degrees, the relay region 30 is a symmetrical trapezoidal shape or an isosceles-like shape, the relay region 30 is symmetrical about the main line.

It is worth noting that, in one embodiment of the present disclosure, as shown in FIG. 13, when a left eye design scheme and a right eye design scheme use the same coordinate system, an angle θ1 between a main line direction m1 and the horizontal direction is designed to ranges from 0 degrees to 90 degrees in the left-eye design scheme, a corresponding angle θ2 between a right-eye main line direction m2 and the horizontal direction may range from 90 degrees to 180 degrees in the right-eye design scheme. Those having ordinary skill in the art should know that the left eye design scheme and the right eye design scheme are the same design concept. Therefore, the angle between the main line direction and the horizontal direction in the left eye design scheme, ranging from 90 degrees to 180 degrees, is equivalent to the angle between the main line direction and the horizontal direction in the right eye design scheme, ranging from 0 degrees to 90 degrees. The right eye design scheme at this time also falls within the scope of protection of embodiments of the present disclosure.

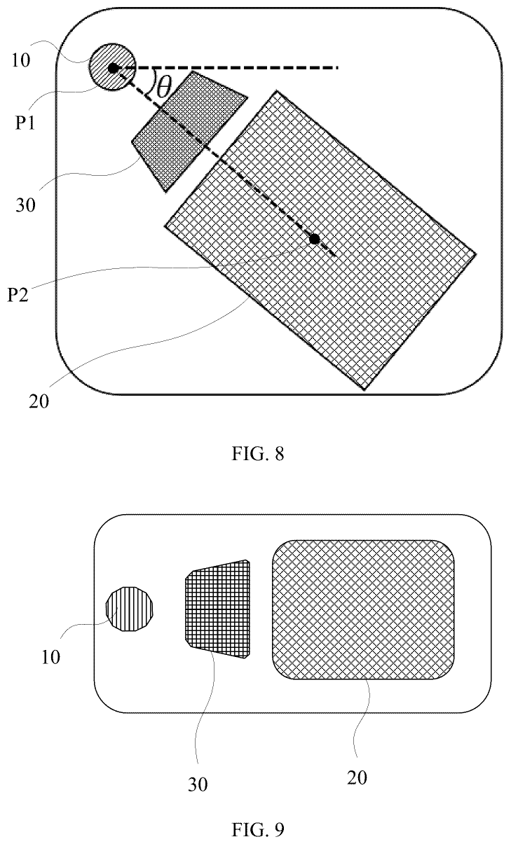

As shown in FIG. 8, the angle θ between the main line direction and the horizontal direction in FIG. 8 ranges from 0 degrees to 90 degrees. In one embodiment, the coupling-out region 20 is rotated, and the relay region 30 is typically a symmetrical trapezoidal shape. The coupling-in region 10 in a circular shape, and the relay region 30 in a symmetric trapezoidal shape and the coupling-out region 20 in a rectangular shape are all symmetrical about the main line.

A height of the symmetrical trapezoidal relay region is not less than a maximum distance of the coupling-in region 10 along the main line, so that a light spot coupled in from the coupling-in region 10 may completely fall into the relay region 30, an upper base of the symmetrical trapezoidal relay region is close to the coupling-in region 10 and parallel to the normal line (perpendicular to the main line), and a lower base of the symmetrical trapezoidal relay region is close to the coupling-out region 20 and parallel to the normal line. In particular, the upper base of the symmetrical trapezoidal relay region is connected to the coupling-out region 20, and/or, the lower base of the symmetrical trapezoidal relay region is connected to the coupling-out region 20.

In one embodiment, the coupling-in grating 40, the relay grating 60 and the coupling-out grating 50 are either a surface relief grating or a holographic gratin. Wherein, the surface relief grating is one of a straight groove relief grating, a slant relief grating, a blazed relief grating, a step relief grating and a curved relief grating.

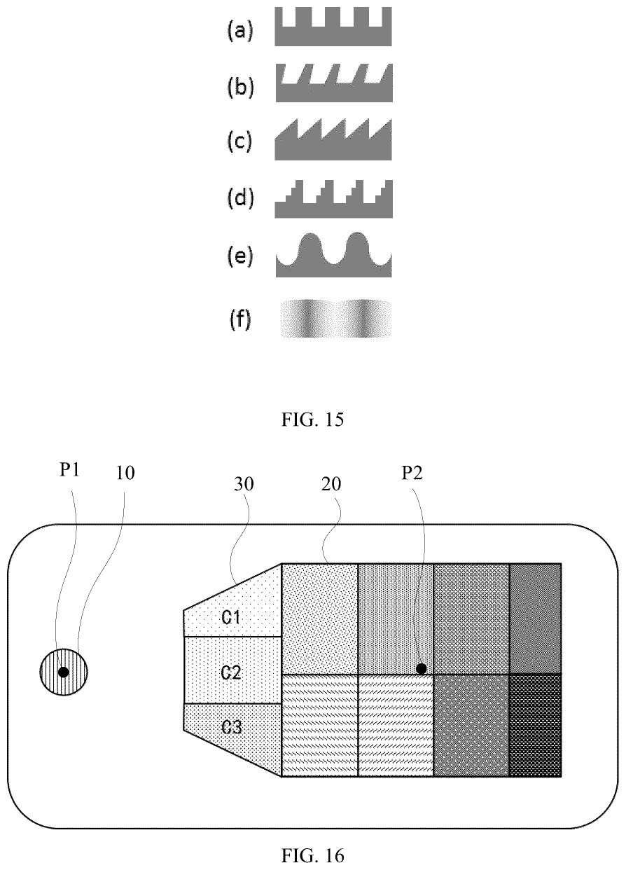

As shown in FIG. 15, the coupling-in grating 40, the relay grating 60 and the coupling-out grating 50 may be all selected from the surface relief grating, which may have straight grooves, slanted teeth, steps, blaze, or curved surface profiles. The coupling-in grating 40, the relay grating 60 and the coupling-out grating 50 may also be all the holographic grating. In FIG. 15, (a) illustrates a straight groove envelope grating, (b) illustrates a slant envelope grating, (c) illustrates a blazed envelope grating, (d) illustrates a step envelope grating, (e) illustrates a curved envelope grating, and (f) illustrates refractive index distribution of a holographic grating. The holographic grating may be made of silver halide, liquid crystal, polymer-dispersed liquid crystal, liquid crystal polymer and other materials. The coupling-in grating 40 and the coupling-out grating 50 may be located on the outside of the optical waveguide substrate 70 (both on one side or on both sides), and may also be configured as inner interlayers.

In one embodiment, the coupling-in region 10 includes at least one first sub-region, the coupling-in grating 40 is arranged on the at least one first sub-region. The relay region 30 includes at least one second sub-region, the relay grating 60 is arranged on the at least one second sub-region. The coupling-out region 20 includes at least one third sub-region, and the coupling-out grating 50 is arranged on the at least one third sub-region; a geometric boundary of sub-regions may be a straight edge or curved edge in any direction.

Specifically, in order to improve energy uniformity of lights coupled out from the coupling-out region 20, sub-regions may be divided in the coupling-in region 10, the relay region 30, and the coupling-out region 20, and by utilizing design freedom of microstructures (shape, duty cycle, groove depth, etc.), energy distribution of lights finally coupled out may be made more uniform, that is, brightness and darkness perceived by the human eyes 300 are more uniform. For example, the coupling-in region 10, the relay region 30, and the coupling-out region 20 have different duty cycles, and/or, have different groove depths.

FIG. 16 illustrates a situation of a plurality of sub-regions, wherein the coupling-in region 10 includes a first sub-region, the relay region 30 includes three second sub-regions, the coupling-out region 20 includes eight third sub-regions. Preferably, the sub-regions are divided along a direction of a grating's outer contour boundary, but this is not limited to the present disclosure.

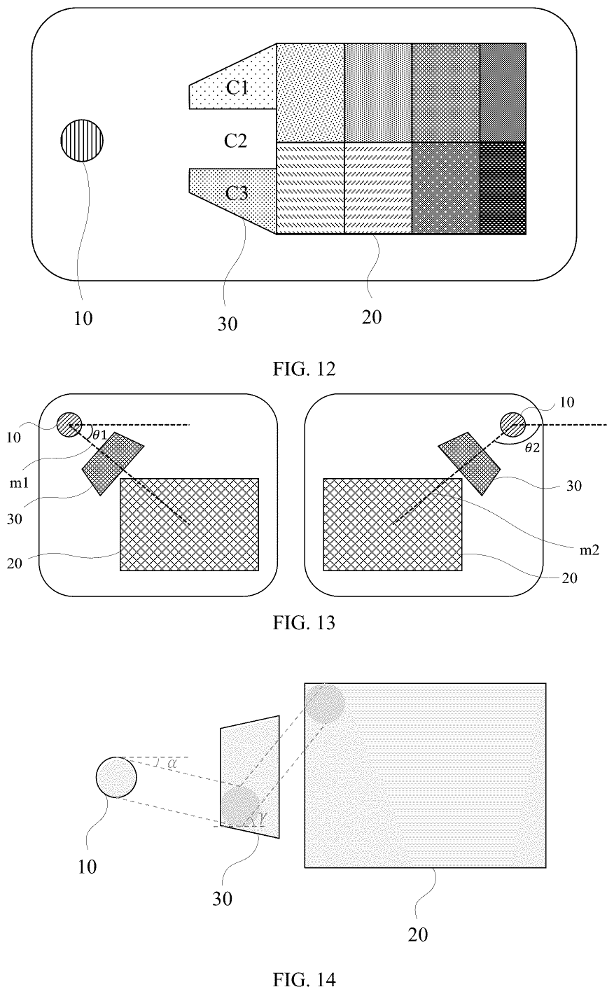

When the number of sub-regions is not less than two, it is also possible for a certain sub-region not to have a grating (this part is configured as a total reflection region). For example, three second sub-regions of the relay region 30 in FIG. 12 correspond to region C₁, region C₂, and region C₃. Two-dimensional gratings may be arranged on two of the region C₁ and the region C₃, while a total reflection region may be arranged on the region C₂, that is the region C₂ may be not configured with a two-dimensional grating. The two two-dimensional gratings are arranged on opposite sides of the region C₂, so that part of lights transmitted from the coupling-in grating 40 may also directly pass through region C₂ in the form of total reflection, and reach the coupling-out region 20, which does not affect transmission of the part of lights. This may reduce area of a two-dimensional grating in the relay region 30, save processing cost, and will not affect transmission of lights.

In one embodiment, as shown in FIG. 17 or FIG. 18, one embodiment of the present disclosure also provides a display device, wherein the display device includes: an optical machine 200, and a diffractive optical waveguide as described in any of the above technical solutions; wherein, the optical machine 200 is configured to emit signal lights towards the diffractive optical waveguide, the coupling-in grating 40 of the diffractive optical waveguide couples the signal lights into the optical waveguide substrate 70, and finally the signal lights are coupled out from the optical waveguide substrate 70 to human eyes 300 at the coupling-out grating 50. In one embodiment, a light-emitting direction of the optical machine 200 is indicated by n1 in FIG. 17 or FIG. 18. a direction of incidence into the human eyes 300 is indicated by n2 in FIG. 17 or FIG. 18.

Specifically, the optical machine 200 is responsible for providing light signals. The coupling-in grating 40 is responsible for receiving the light signals and transmitting the light signals to the coupling-out grating 50. There is a relay grating 60 between the coupling-in grating 40 and the coupling-out grating 50 to improve transmission effect. The coupling-in grating 40, the relay grating 60, and the coupling-out grating 50 may perform one-dimensional or two-dimensional pupil expansion on light beams, and the coupling-out grating 50 finally outputs the expanded light signals and projects them into human eyes 300.

Preferably, the display device is an augmented reality glasses. Since the augmented reality glasses includes a diffractive optical waveguide described in the above technical solutions, the augmented reality glasses without introducing additional optical machines, without increasing lens area, or without increasing process complexity, may increase energy of coupling-out lights, enhances viewing brightness for human eyes 300, or reduces output energy requirements of the optical machine 200 while maintaining the same viewing brightness for human eyes 300. Moreover, the augmented reality glasses may improve uniformity of coupled-out energy at various field of view angles, and enhance viewing comfort of human eyes 300. Additionally, while ensuring the viewing effect, the augmented reality glasses may also reduce ineffective processing area of a grating, and reduce manufacturing cost.

In summary, the present disclosure provides a diffractive optical waveguide and an augmented reality glasses, including: an optical waveguide substrate 70, and at least one coupling-in region 10, at least one relay region 30, and at least one coupling-out region 20 disposed on the optical waveguide substrate 70; each relay region 30 is arranged between the coupling-in region 10 and the coupling-out region 20; a coupling-in grating 40, arranged in the coupling-in region 10, wherein the coupling-in grating 40 is configured to couple lights into the optical waveguide substrate 70 and transmit the lights to the relay region 30 and the coupling-out region 20; a relay grating 60, arranged in the relay region 30, wherein the relay grating 60 is configured to change a transmission path of lights so that the lights may cover the coupling-out region 20; a coupling-out grating 50, arranged in the coupling-out region 20, wherein the coupling-out grating 50 is configured to couple lights out from the coupling-out region 20. In the present disclosure, the relay grating 60 may change a transmission path of part of the lights, so that when lights coupled in from the coupling-in grating 40 is transmitted to the coupling-out region 20 through the relay grating 60, and may cover a more complete coupling-out region 20. This avoids problem of weak coupling-out energy in some regions of the coupling-out region 20 which would result in a loss of fields of view when viewed by human eyes 300. At the same time, adding a relay region 30 increases design freedom, which may improve energy utilization efficiency.

It should be understood that application of the present disclosure is not limited to the above examples, and those having ordinary skill in the art may make improvements or transformations according to the above descriptions, and all such improvements and transformations should fall within protection scope of claims of the present disclosure.

What is claimed is:

1. A diffractive optical waveguide, comprising:
an optical waveguide substrate, and at least one coupling-in region, at least one relay region, and at least one coupling-out region disposed on the optical waveguide substrate; each relay region is arranged between the coupling-in region and the coupling-out region;
a coupling-in grating, arranged in the coupling-in region, wherein the coupling-in grating is configured to couple lights into the optical waveguide substrate and transmit the lights to the relay region and the coupling-out region; the coupling-in grating is a one-dimensional grating or a two-dimensional grating;
a relay grating, arranged in the relay region, wherein the relay grating is configured to change a transmission path of the lights so that the lights cover the coupling-out region; and
a coupling-out grating, arranged in the coupling-out region, wherein the coupling-out grating is configured to couple lights out from the coupling-out region; the relay grating and the coupling-out grating are both two-dimensional gratings; the coupling-in region and the coupling-out region are both symmetrical in shape, the relay region is symmetrical or asymmetrical in shape.

2.-11. (canceled)

12. The diffractive optical waveguide according to claim 1, wherein the coupling-in region and the coupling-out region both have an equivalent center, the equivalent center is a centroid position when a geometric shape is regarded as an object with uniform density; a line connecting the equivalent center of the coupling-in region and the equivalent center of the coupling-out region is a main line;
a side of the relay region close to the coupling-in region is perpendicular to the main line, an opposite side of the relay region close to the coupling-out region is perpendicular to the main line.

13. The diffractive optical waveguide according to claim 1, wherein the relay region is an isosceles trapezoidal shape or a symmetrical trapezoidal-like shape;
the coupling-in region and the coupling-out region both have an equivalent center, the equivalent center is a centroid position when a geometric shape is regarded as an object with uniform density; a line connecting the equivalent center of the coupling-in region and the equivalent center of the coupling-out region is a main line; an upper base of the relay region is close to the coupling-in region, a lower base of the relay region is close to the coupling-out region, the upper base and the lower base are both perpendicular to the main line.

14. The diffractive optical waveguide according to claim 1, wherein the coupling-in region is a circular shape or a similar shape, the coupling-out region is a rectangle or a similar shape, and the relay region is a trapezoidal shape or a trapezoidal-like shape.

15. The diffractive optical waveguide according to claim 14, wherein the coupling-in region and the coupling-out region both have an equivalent center, the equivalent center is a centroid position when a geometric shape is regarded as an object with uniform density; a line connecting the equivalent center of the coupling-in region and the equivalent center of the coupling-out region is a main line;
an angle between a direction of the main line and a horizontal direction ranges from 0 degrees to 90 degrees, an upper base of the relay region is close to the coupling-in region, and the upper base is perpendicular to the main line, and a lower base of the relay region is close to the coupling-out region, and the lower base is perpendicular to the main line, a straight-line distance between the upper base and the lower base of the relay region along the direction of the main line is defined as a height of the relay region, the height of the relay region is not less than a maximum distance of the coupling-in region along the main line.

16. The diffractive optical waveguide according to claim 1, wherein the relay region is connected to the coupling-in region and/or the coupling-out region, the relay region is a trapezoidal shape; an upper base of the trapezoidal relay region is connected to the coupling-in region, and/or, a lower base of the trapezoidal relay region is connected to the coupling-out region.

17. The diffractive optical waveguide according to claim 16, wherein the lower base of the trapezoidal relay region is the same length as a side of the coupling-out region 20 close to the trapezoidal relay region.

18. The diffractive optical waveguide according to claim 1, wherein the coupling-in region and the coupling-out region both have an equivalent center, the equivalent center is a centroid position when a geometric shape is regarded as an object with uniform density; a line connecting the equivalent center of the coupling-in region and the equivalent center of the coupling-out region is a main line; an angle between a direction of the main line and a horizontal direction is 0 degrees, the relay region is a symmetrical trapezoidal shape or an isosceles-like shape, the isosceles-like shape is symmetrical about the main line.

19. The diffractive optical waveguide according to claim 1, wherein the coupling-in region and the coupling-out region both have an equivalent center, the equivalent center is a centroid position when a geometric shape is regarded as an object with uniform density; a line connecting the equivalent center of the coupling-in region and the equivalent center of the coupling-out region is a main line; an angle between a direction of the main line and a horizontal direction is 90 degrees, the relay region is a symmetrical trapezoidal shape or an isosceles-like shape, the relay region is symmetrical about the main line.

20. The diffractive optical waveguide according to claim 1, wherein the coupling-in region and the coupling-out region both have an equivalent center, the equivalent center is a centroid position when a geometric shape is regarded as an object with uniform density; a line connecting the equivalent center of the coupling-in region and the equivalent center of the coupling-out region is a main line;
a direction of the main line of the diffractive optical waveguide corresponding to a left eye is defined as a left-eye main line direction, an angle between the left-eye main line direction and a horizontal direction ranges from 0 degrees to 90 degrees; a direction of the main line of the diffractive optical waveguide corresponding to a right eye is defined as a right-eye main line direction, an angle between the right-eye main line direction and a horizontal direction ranges from 90 degrees to 180 degrees.

21. The diffractive optical waveguide according to claim 1, wherein the coupling-in region and the coupling-out region both have an equivalent center, a line connecting the equivalent center of the coupling-in region and the equivalent center of the coupling-out region is a main line; an angle between a direction of the main line and a horizontal direction ranges from 0 degrees to 90 degrees, the coupling-in region in a circular shape, the relay region in a symmetric trapezoidal shape and the coupling-out region in a rectangular shape are both symmetrical about the main line.

22. The diffractive optical waveguide according to claim 1, wherein the coupling-in region, the relay region, and the coupling-out region have different shapes.

23. The diffractive optical waveguide according to claim 1, wherein the coupling-in region, the relay region, and the coupling-out region have different duty cycles, and/or, have different groove depths.

24. The diffractive optical waveguide according to claim 1, wherein the coupling-in region is one of oval, rectangle, square, polygon, rounded rectangle, rectangle with chamfers shape; the coupling-out region is one of an oval, rectangle, square, polygon, rounded rectangle, rectangle with chamfers shape; the relay region is a triangle shape.

25. The diffractive optical waveguide according to claim 1, wherein the coupling-in grating, the relay grating and the coupling-out grating are either a surface relief grating or a holographic grating;
wherein, the surface relief grating is one of a straight groove relief grating, a slant relief grating, a blazed relief grating, a step relief grating and a curved relief grating.

26. The diffractive optical waveguide according to claim 1, wherein the coupling-in region comprises at least one first sub-region, the coupling-in grating is arranged on the at least one first sub-region;
the relay region comprises at least one second sub-region, the relay grating is arranged on the at least one second sub-region;
the coupling-out region comprises at least one third sub-region, and the coupling-out grating is arranged on the at least one third sub-region;
a geometric boundary of the sub-regions is a straight edge or curved edge in any direction.

27. The diffractive optical waveguide according to claim 1, wherein the relay region comprises three second sub-regions, two-dimensional gratings are arranged on two of the three second sub-regions, the remaining one of the three second sub-regions is not configured with a two-dimensional grating, and the two two-dimensional gratings are arranged on opposite sides of the remaining one of the three second sub-regions.

28. The diffractive optical waveguide according to claim 1, wherein the coupling-in grating, the relay grating, the coupling-out grating are positioned on one or both sides of the optical waveguide substrate, or inside the optical waveguide substrate;
the diffractive optical waveguide is configured with one or more layers of optical waveguide substrates; when the diffractive optical waveguide has multi-layer optical waveguide substrates, each layer of optical waveguide substrate is configured with a grating.

29. An augmented reality glasses, comprising:
an optical machine, and a diffractive optical waveguide according to claim 1;
wherein, the optical machine is configured to emit signal lights towards the diffractive optical waveguide, the diffractive optical waveguide couples the signal lights into the optical waveguide substrate and couples out the signal lights to human eyes.

30. A display device, comprising:
an optical machine, and a diffractive optical waveguide according to claim 1;
wherein, the optical machine is configured to emit signal lights towards the diffractive optical waveguide, the diffractive optical waveguide couples the signal lights into the optical waveguide substrate and couples out the signal lights to human eyes.
